(19) United States
(12) Patent Application Publication
(10) Pub. No.: US 2011/0006028 A1
(43) Pub. Date: Jan. 13, 2011

(54) COATED GLASS BOTTLES AND ARTICLES AND METHODS OF MANUFACTURE

(75) Inventor: Gregory Caldwell, Stow, OH (US)

Correspondence Address: HAHN LOESER & PARKS, LLP, One GOJO Plaza, Suite 300, AKRON, OH, 44311-1076, US

(73) Assignee: GREG CALDWELL COMPANY, LLC, Akron, OH (US)

(21) Appl. No.: 12/833,629

(22) Filed: Jul. 9, 2010

Related U.S. Application Data
(60) Provisional application No. 61/224,516, filed on Jul. 10, 2009.

(51) Int. Cl. A61J 9/00; B65D 23/00; B05D 3/00; B05D 3/02; B05D 1/18

(52) U.S. Cl. 215/11.1; 215/12.2; 427/387

(57) ABSTRACT

There is described glass baby and drinking articles, or other glass articles, that are coated with a BPA free, shatterproof silicone sleeve. The coated glass bottles provide peace of mind that parents seek when feeding their babies, and prevent the bottle from shattering or “exploding” if or when dropped. The coated bottle provides shock resistance to prevent breakage in many typical drops, or total glass containment with the silicone sleeve if the bottle does break. The shatterproof silicone coated glass baby bottle and containment system is ideal for active parents who will accept nothing but the safest products for their young kids while eliminating all worries of BPA and glass breakage. The coating also provides thermal insulation to maintain the temperature of liquids disposed therein and keep the heat (or cold) of liquids in the bottle from migrating to the hand of the baby or other person handling the bottle. The silicone sleeve is adhered directly to the glass baby bottle, providing better gripping characteristics, without slippage. Methods of manufacturing silicone coated glass articles by dipping a glass article in a solvent dispersion of uncured silicone rubber to provide one or more layers is also provided, or a method for injection overmolding of a coating on the bottle.

### CROSS-REFERENCE TO RELATED APPLICATIONS

This patent application claims the benefit of U.S. Provisional Patent Application No. 61/224,516 filed Jul. 10, 2009, the disclosure of which is expressly incorporated by reference herein.

### TECHNICAL FIELD

The invention generally contemplates providing new and improved glass articles such as baby bottles, or drinking glasses, having a silicone coating, such as used for feeding of babies, or holding beverages, and processes of manufacturing silicone coated glass bottles and articles made from solvent dispersions which form a substantially uniform coating on the glass articles.

### BACKGROUND

In recent years, baby bottles and other such articles have been produced of plastic materials, particularly polycarbonate plastics which include the chemical bisphenol A (BPA). Bisphenol A is an organic compound with two phenol functional groups. It is a difunctional building block of several plastics and plastic additives, and a monomer used in the production of polycarbonate. Polycarbonate plastic is a clear and nearly shatter-proof material, which was found attractive for use in making a variety of common products including baby and water bottles as well as other articles. Recently, the chemical BPA is suspected of being hazardous to humans, and concerns about the use of BPA in consumer products has been targeted as being unsafe. Particularly susceptible are infants fed with liquid formula from a BPA containing bottle, which have been found to have significant exposure. For example, babies fed formula from polycarbonate bottles can consume up to 13 micrograms of BPA per kg of body weight per day. Infants may be particularly susceptible to BPA's endocrine-disrupting potential. New research from the US suggests that people who drink from bottles made of polycarbonate plastic, such as that used to make hard-plastic drinking bottles and baby bottles, have a considerably higher level of the chemical BPA in their bodies compared to when they do not.

The finding confirms concerns expressed by consumer groups and public health experts, that polycarbonate plastic bottles are an important source of the BPA that finds its way into the human body. BPA has been shown to interfere with reproductive development in animals, and has been linked to cardiovascular disease and diabetes in humans, among other things. Studies have shown that BPA can leach from the container into the liquid, and thereby result in a corresponding increase of intake into the body. If such bottles are heated, as is the case with baby bottles, the levels of leaching can be considerably higher. Hard plastic polycarbonate bottles are often used as refillable containers by others, such as people when working out, athletes, students, and others. It has also been found that drinking cold liquids from polycarbonate bottles increases the BPA levels ingested.

At the same time, glass articles which avoid the BPA issues are subject to breakage if dropped, which is particularly problematic with baby bottles or other articles such as beer glasses. There is also the potential for thermal shock to cause breakage of the glass container, such as when the glass article is placed into boiling water from being in the refrigerator or freezer for example, or having a cold beverage poured into it when hot. Between harmful plastics and glass breakage, there is a need for baby or other bottles, beer glasses and glass articles that alleviate these issues.

### SUMMARY

The invention is thus directed to glass articles such as baby bottles, drinking bottles and glasses, or other glass articles and vessels such as, but not limited to beer glasses, wine bottles, beakers, pharmaceutical containers, fragrance containers or the like, or other articles that can be coated with an elastomer coating, such as a BPA free, shatterproof silicone sleeve. The coated glass baby bottles for example, provide peace of mind that parents seek when feeding their babies, and prevent the bottle from shattering or “exploding” if or when dropped. The coated glass articles according to the invention provide shock resistance to prevent breakage in many typical drops, or total glass containment with the elastomer sleeve if the glass article does break. The shatterproof silicone coated glass baby bottle and containment system is ideal for active parents who will accept nothing but the safest products for their young kids while eliminating all worries of BPA and glass breakage. The coating also provides thermal insulation to maintain the temperature of liquids disposed therein and keep the heat (or cold) of liquids in the glass article from migrating to the hand of the baby or other person handling the glass article, and prevents thermal shock from causing breakage. The coating may use FDA compliant silicone materials to form the sleeve that will contain the glass and any liquids, or other elastomer or polymeric materials. The silicone sleeve is adhered directly to the glass baby bottle or glass article, providing better gripping characteristics, without slippage.

The use of curable elastomeric silicone compositions for coating glass articles such as baby bottles, drinking bottles and glasses, or other glass substrates according to the invention provides for increased tensile strength in the coated article. In examples, the coating may be clear or employ a large spectrum of colors, embossed or other designs or the like, while allowing viewing of the contents. The coating is chemically stable at higher temperatures and the glass articles can be machine washed, microwaved, boiled or the like. The coating has a long shelf life without degradation, and bonds to the glass substrate. The coating may be applied and cured at relatively cool temperatures, and the coating is formed so as to be substantially free of encapsulated bubbles.

There are also provided methods of producing the coated glass articles, including a dipping process. Such a method provides for use of apparatus for coating one or more glass articles with a protective material by dipping the glass articles into the protective material which is in a dip tank. A fixture for holding a plurality of glass articles is provided and used in association with a computer-controlled two or three axis automatic dipping unit. The dipping system may allow dipping recipes to be developed for different glass articles, and precise dipping steps employed and operated by computer. The system may have one or more extended mounting arms for receiving multiple holding fixtures for mounting the glass articles for dipping. A separate dip tank may be used which includes automatic temperature, viscosity, level and mixing controls to provide a dipping solution having the desired characteristics which is uniform over multiple dipping cycles. A dip tank shuttle may be used to allow multiple dipping cycles to be performed quickly using multiple mounting arms. The dipping system may be contained in an enclosure to allow control of and evacuation and treatment of evaporated solvents. A programmable laminar flow drying system may be provided in association with the dipping system to facilitate higher production capabilities.

In another example, the coated glass articles are produced using an injection molding process. For example the glass baby bottle may be formed by injection molding wherein the glass bottle is held in a fixture in association with a mold, to prevent breakage of the bottle when clamped in the mold, and the liquid silicone is injected around the bottle and cured to form the coated bottle configuration.

Other configurations, such as incorporating a temperature sensing device in conjunction with the glass article, providing decoration such as by embossing, or other configurations are contemplated.

These and other aspects of the present invention will be apparent to one skilled in the art from the following description.

### BRIEF DESCRIPTION OF THE DRAWINGS

FIG. 1 is a cross sectional view of a baby bottle with a coating provided thereon according to an example of the invention;

FIG. 2 is a cross sectional view of a glass bottle with a coating provided thereon according to an example of the invention;

FIG. 3 is a cross sectional view of a drinking glass with a coating provided thereon according to an example of the invention;

FIG. 4 is a flow chart of a method according to an example of the invention;

FIG. 5 is a side elevation showing the a dipping system for a plurality of glass articles;

FIG. 6 is a cross sectional view of an injection molding arrangement for producing the coated glass article according to an example; and

FIG. 7 is an alternate example of a coated glass article with a temperature sensor associated therewith according to an example.

### DETAILED DESCRIPTION OF THE DRAWINGS

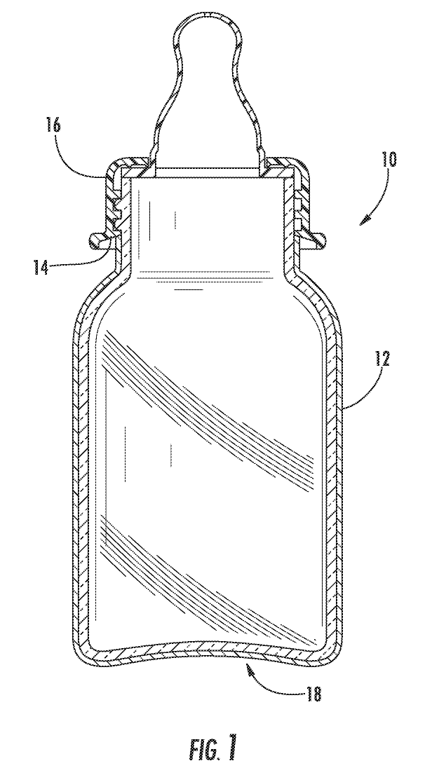

With reference now to the drawings, and in particular to FIG. 1, a baby bottle 10 coated with a BPA free, shatterproof silicone sleeve 12 is shown. The bottle 10 generally has a concave bottom surface 18. The coating 12 extends to a lip 14 below the level of threads used to secure a cap 16 thereon. The coated glass bottle 10 provides peace of mind that a parent seeks when feeding their babies, and prevents the bottle 10 from shattering or “exploding” if or when dropped. The coating 12 on the bottle 10 provides shock resistance to prevent breakage of the glass bottle 10 in many typical drops, such as from a high chair, stroller, table or the like. If the bottle 10 does break, the sleeve 12 provides total glass containment within the silicone sleeve, and also fully contains any liquid, to prevent the mess that would occur otherwise if the bottle does break. The shatterproof silicone coated glass baby bottle and containment system is ideal for active parents who will accept nothing but the safest products for their young kids while eliminating all worries of BPA and glass breakage. The coating 12 according to an example uses FDA compliant silicone materials to form the sleeve 12, that are safe and durable. The silicone sleeve 12 is adhered directly to the glass baby bottle, to prevent slippage, and provide better gripping characteristics for the parent or child, without slippage. The coating 12 is transparent or translucent to allow the contents contained therein to be seen. Additionally, branding or decoration may be applied to the bottle 10 prior to coating, which may then be seen behind the coating 12. The coating 12 may also have color, sparkles or other decorative features incorporated therein to provide aesthetic appeal. As the coating 12 is directly adhered to the bottle 10, it may be machine washed, such as in a dishwasher, without degradation, or water ingress behind the coating, and at high temperature for disinfecting. The coated bottle is also microwavable without degradation of the coating 12. The coating 12 also provides thermal insulation to maintain the temperature of liquids disposed therein and keep the heat (or cold) of liquids in the bottle from migrating to the hand of the baby or other person handling the bottle 10. Other glass bottles, such as drinking bottles may be coated similarly, or other glass articles such as beakers or the like. The coating 12 may be easily applied to different size or shape glass articles. The coated glass articles provide the benefits of having a BPA free drinking bottle or glass articles for other purposes, while providing shatter and shock resistance and/or full containment of the glass (and liquid using a top) if the bottle or article does break.

In this example, the protective material of coating or sleeve 12 is formed of a FDA food contact approved silicone material, such as Elastosil® products from Wacker Chemical Co. or Silastic® products from Dow Corning, but other suitable silicone materials may be used, or other suitable materials such as natural rubber. This material is crystal clear, non-toxic, and allows application via dipping and/or injection molding for example. The coating 12 is formed to have a thickness of between 0.3 mm to 1.5 mm, or for many baby bottle configurations, between about 0.5 to 1.2 mm, but other thicknesses may be suitable depending on the application. Thicknesses of up to ¼ inch are possible for example, and different thicknesses are easily achieved in manufacture. The thickness of the coating 12 is designed to resist tearing, such as if the glass does break, and thus to retain any glass and liquid therein. The coating 12 may have a durometer of 20 A to 80 A for example, with durometer adjustable for the application.

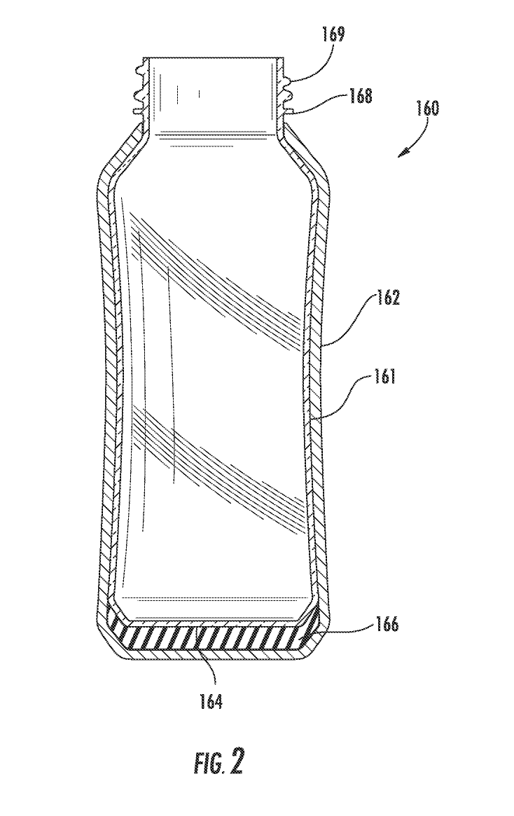

FIG. 2 shows another example of the invention, wherein a glass bottle 160, such as a baby bottle, is coated with BPA free, shatterproof silicone sleeve coating 162. The bottle 160 is generally made from glass 161 and has a generally rounded bottom surface 164 with a protective bumper 166. The protective bumper may be formed as a separate member as shown, or may be formed from the coating 162 itself. The bottom surface 164 may be more rounded, such as somewhat spherical, which may also facilitate providing additional impact strength and shock resistance. The coating 162 extends to a lip 168 immediately below the threads 169 used to secure a cap (not shown) thereon. The bumper 166 may be a separate member as shown, and in this event, the coating 162 also encompasses the protective bumper 166. The protective coating 162 helps prevent the coated glass bottle 160 from shattering or “exploding” if or when dropped. The coating 162 on the bottle 160 provides shock resistance to prevent breakage of the glass bottle 160 in many typical drops. Further, the form of the bottle 160 with a rounded bottom may be simpler to produce, and the use of a bumper 166 (formed as a separate member or of coating 162), allows a flat bottom to be formed on the bottle 160 to facilitate having it stand upright on a surface. The bumper 166 also provides shock resistance upon dropping, as many drops will involve the bottom area of the bottle 160. If the glass 161 of the bottle 160 does break, the protective coating 162 provides total glass containment within the silicone sleeve 162, and also fully contains any liquid, to prevent the mess that would occur otherwise if the bottle 160 does break. The optional protective bumper 166 is operatively attached to the bottom surface 164 of the glass 161 forming the glass bottle 160 and is within the protective coating 162. The protective bumper 166 adds additional protection to the glass bottle 160 in the event of a typical drop. The small additional weight of the protective bumper 166 will have additional feature of tending to orient the glass bottle 160 in free-fall with the bottom surface 164 of the glass bottle 160 pointing toward the ground. The protective bumper 160 is formed of shock absorbent material such as silicone, rubber, polymer compound or other like material allowing the impact of the bottle 162 hitting the ground to be absorbed by the protective bumper 166. It has been found that the provision of the coating 162 provides greatly increased performance in preventing glass breakage in drop tests, and the further provision of a bumper 166 also provides much increased performance if the article is dropped in a manner that the bumper 166 receives at least some of the impact.

The coating 162 according to an example uses FDA compliant silicone materials to form the coating 162, that are safe and durable. The silicone coating 162 is adhered directly to the glass bottle 160. Having the silicone coating 162 adhere directly to the glass bottle 160 improves the gripability of the glass bottle 160, reducing slippage when holding bottle 160. The coating 162 may be transparent or translucent to allow the contents contained in the glass bottle 160 to be seen. Additionally, branding or decoration may be applied to the glass 161 of the bottle 160 prior to coating, which may then be seen behind coating 162. The coating 162 may also have color, sparkles or other decorative features incorporated therein to provide aesthetic appeal. As coating 162 is adhered to the glass 161 of bottle 160, the bottle 160 may be machine washed, such as in a dishwasher, without degradation, or water ingress behind the coating 162, and at high temperatures for disinfecting. The coated bottle 160 is also microwaveable without degradation to coating 162. The coating 162 also provides thermal insulation to maintain the temperature of the contents of the glass 160 and keep the heat (or cold) of the contents of the glass 160 from migrating to the hand of the holder of the bottle 160. An additional advantage of coating 162 is the added strength and impact resistance it provides to glass bottle 160, allowing for a reduced thickness of glass 161 being required to form the glass bottle 160. Using a reduced thickness of glass 161 simplifies the manufacturing process and reduces the weight and cost of the glass 161 used to make the bottle 160.

The protective bumper 166 has the additional advantage of being able to forego any necessity of having to incorporate a heavy glass bottom into the glass 161 forming the glass bottle 160. Thus allowing for a uniform thickness for glass 161 along the lower portion of the glass bottle 160 below the lip 168. Glass 161 having a uniform thickness allows for a simplified manufacturing process where the lower portion of the glass 161 below the lip 168 cools down at a uniform rate once it has been formed, decreasing the time needed to cool the glass, reducing the complexity and cost of the manufacturing process and reducing the potential for cracking during cooling. Decreasing the thickness of the glass 161 allows for an increase in the flexibility of glass 161 making glass 161 more resistant to shattering and breaking due to dropping, and also from thermal expansion and contraction, for example, while heating in a microwave or washing in hot water.

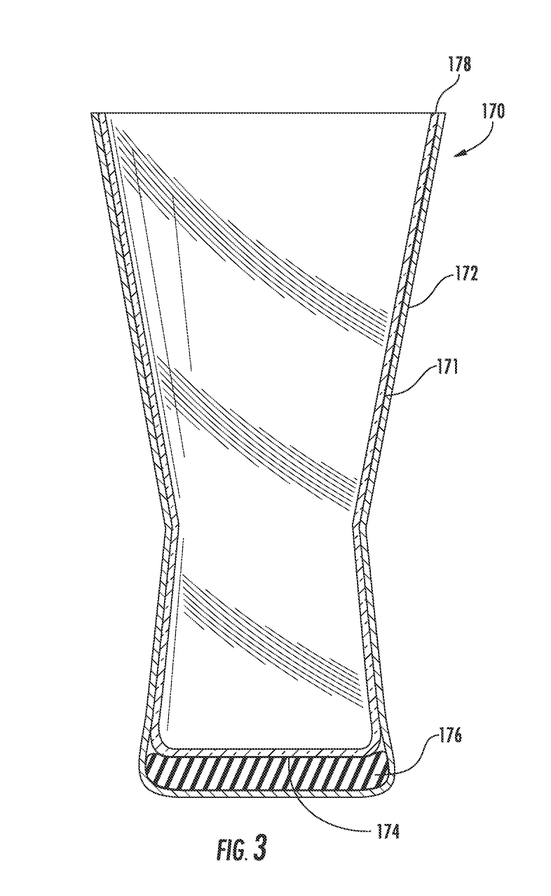

FIG. 3 shows a further example of the invention, wherein a drinking glass 170, such as a beer glass, is coated with BPA free, shatterproof silicone sleeve coating 172. The drinking glass 170 is generally made from glass 171 and has a generally flat bottom surface 174. Optionally, drinking glass 170 may have a generally rounded bottom surface 174. In this example, there also may be provided a molded protective bumper 176, formed as a separate member as shown or of the coating 172 itself. The coating 172 extends to the rim 178 of the drinking glass 170, or if desired, to a position slightly below the rim so the user feels the glass portion upon drinking. The coating 172 may also encompasses the bottom surface 174, and the protective bumper 176 if provided as a separate member. The protective coating 172 helps prevent the coated glass drinking glass 170 from shattering or “exploding” if or when dropped. The coating 172 on the drinking glass 170 provides shock resistance to prevent breakage of the glass drinking glass 170 in many typical drops. If the glass 171 of the drinking glass 170 does break, the protective coating 172 provides glass containment within the silicone sleeve 172. The bumper 176 may be formed as a separate protective bumper 176 which is operatively attached to the bottom surface 174 of the glass 171 forming the glass drinking glass 170 and is within the protective coating 172, or as a thickened portion of the coating 172. The protective bumper 176 adds additional protection to the glass drinking glass 170 in the event of a typical drop. The small additional weight of the protective bumper 176 will have the additional feature of tending to orientate the glass drinking glass 170 in free-fall with the bottom surface 174 of the glass drinking glass 170 pointing toward the ground. The protective bumper 170 is formed of shock absorbent material such as silicone, rubber, polymeric compound or other similar material, allowing the impact of the drinking glass 172 hitting the ground to be absorbed by the protective bumper 176.

The coating 172 according to an example uses FDA compliant silicone materials to form the coating 172, that are safe and durable. The silicone coating 172 is adhered directly to the glass drinking glass 170. Having the silicone coating 172 adhere directly to the glass drinking glass 170 improves the gripability of the glass drinking glass 170, reducing slippage when holding. The coating also provides some insulation, and generally will minimize condensation on the outer surface of the glass 170 which may normally occur with just the glass. The coating 172 is transparent or translucent to allow the contents contained in the glass drinking glass 170 to be seen. Additionally, branding or decoration may be applied to the glass 171 of the drinking glass 170 prior to coating, which may then be seen behind coating 172. The coating 172 may also have color, sparkles or other decorative features incorporated therein to provide aesthetic appeal. As coating 172 is adhered to the glass 171 of drinking glass 170, the drinking glass 170 may be machine washed, such as in a dishwasher, without degradation, or water ingress behind the coating 172, and at high temperatures for disinfecting. The coated drinking glass 170 is also microwaveable without degradation to coating 172. The coating 172 also provides thermal insulation to maintain the temperature of the contents of the glass 170 and keep the heat (or cold) of the contents of the glass 170 from migrating to the hand of the holder of the drinking glass 170. An additional advantage of coating 172 is the added strength and impact resistance it provides to glass drinking glass 170, allowing for a reduced thickness of glass 171 being required to form the glass drinking glass 170. Using a reduced thickness of glass 171 simplifies the manufacturing process and reduces the weight and cost of the glass 171 used to make the drinking glass 170.

The optional protective bumper 176 has the additional advantage of being able to forego any necessity of having to incorporate a heavy glass bottom into the glass 171 forming the glass drinking glass 170, which is typically done with beer glasses for example. Thus allowing for a uniform thickness for glass 171 along the lower portion of the glass drinking glass 170 below the rim 178. Glass 171 having a uniform thickness allows for a simplified manufacturing process where the lower portion of the glass 171 below the rim 178 cools down at a uniform rate once it has been formed, decreasing the time needed to cool the glass, reducing the complexity of the manufacturing process and reducing the potential for cracking during cooling. Decreasing the thickness of the glass 171 allows for an increase in the flexibility of glass 171 making glass 171 more resistant to shattering and breaking due to dropping, and also from thermal expansion and contraction, for example, while heating in a microwave or washing in hot water.

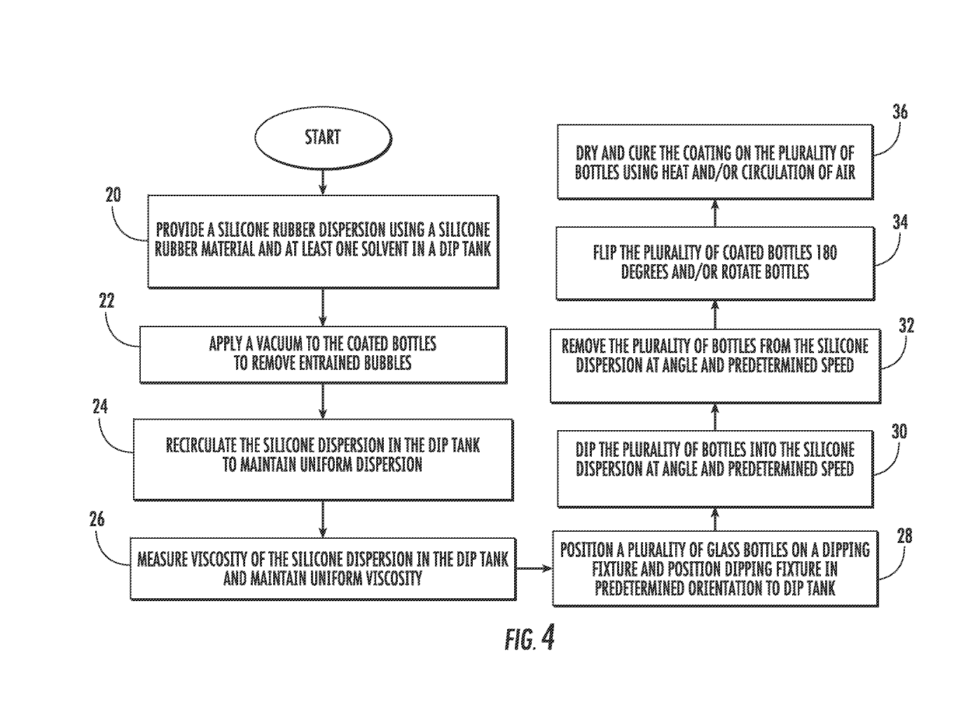

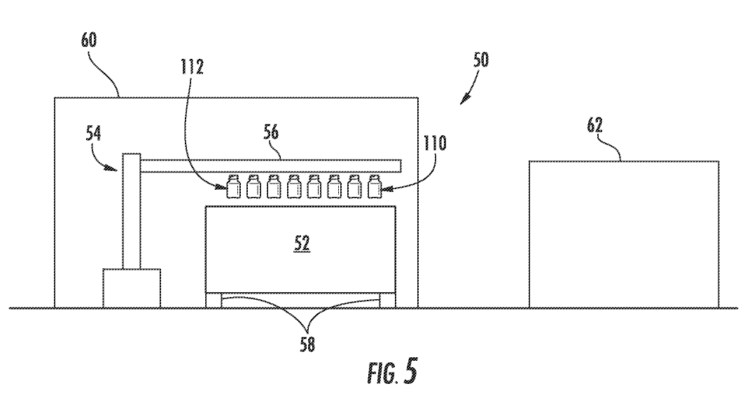

A person of ordinary skill in the art will appreciate that other examples of the invention include providing a coating and optionally a protective bumper, as described in the examples above, for other glass articles such as beakers, wine bottles, canning jars, pharmaceutical containers, syringes, fragrance bottles, and other such glass articles capable of being coated by a BPA free, shatterproof, silicone, coating. Different Food Grade coatings, such as plastic, PVB, HDPE, Plasti-Dip materials may be usable to allow coating of the glass articles, such as by dipping in a manner similar to the silicone as described. As seen in FIGS. 4 and 5, a first process for forming the coating 112 on glass articles 110 may be a dipping process which includes the steps of providing a liquid silicone dispersion using at least one solvent at 20 in a dip tank 52. The dispersion of base polymer in at least one solvent comprises about 30-65% by weight of base polymer. For example, the silicone rubber mixture may include multiple components, which in an example are Elastosil® A and Elastosil® B, in equal amounts of 25% each, along with at least one solvent to form a dispersion of silicone rubber. A cross-linking agent may be added to the dispersion at the time it is placed in the dipping tank. For example, the silicone rubbers which may be used to form the coating 112 have as a base elastomer or polymer an organopolysiloxane and may utilize either platinum, benzoyl peroxide, dichlorobenzoyl peroxide or other suitable vulcanization/curing systems. Fillers may also be used in the rubber composition to increase tensile strength and reinforcing silicone fillers which are inert to animal fluids and tissues when used as an integral part of the rubber formulation. Suitable silicone rubber base polymers are known to those skilled in the art. Contemplated solvents include any suitable pure or mixture of organic, organometallic or inorganic molecules that are volatilized at a desired temperature. The solvent may also comprise any suitable polar and non-polar compounds. In an example, the solvent comprises about 40% heptane and 8-10% D-limonene, but other amounts of these solvents may be used. Other solvents such as, toluene, pentane, hexane, cyclohexane, benzene, xylene, halogenated solvents such as carbon tetrachloride, and mixtures thereof or others may be suitable. The silicone dispersion may further include one or more colorants in an amount such as between about 1-2% and/or decorative materials such as sparkles in an amount such as 1-2%. A vacuum is applied at 22 to remove any entrained bubbles from the coating 112 by degassing. The silicone dispersion is maintained in a uniform mixture by vacuum pumping of the mixture in the tank through suitable filters, such as metal mesh filters, by a recirculating pump at 24. Other methods such as stifling may also be used. The laminar flowability of the mixture is maintained during one or more dipping cycles. The viscosity of the mixture is measured and maintained at 26 by the addition of constituents as needed between dipping cycles. The viscosity of the dispersion may be in the range of 2500-7900 centipoises, or according to an example, about 5000-5500 cp. The viscosity allows the desired thickness of the coating 112 to be obtained in one or more dipping cycles, and is set to allow any entrained bubbles to be effectively removed upon application of a vacuum or de-gassing step as described below. A plurality of glass articles 110 are positioned on a dipping fixture at 28, and lowered into the dip tank at a predetermined angle relative to the dispersion and at a predetermined speed at 30. The angle is generally between 5-20 degrees relative to the horizontal surface of the dispersion, depending, for example on the depth of a concave bottom surface of the glass article 110. In one example the glass articles 110 have a concave bottom surface, therefore the angled approach and removal eliminates any formation of a bubble at the concave bottom surface and ensures uniform coating thereof. If there is no concave bottom surface as in the examples of FIGS. 2 and 3, the angling of the glass article 110 into the dispersion may not be necessary. The speed at which the glass articles 110 are dipped is generally substantially uniform and between about 50 to 100 mm/second, for example. The substantially uniform speed of dipping into and from dip tank 52 provides a substantially uniform thickness coating 112 on the glass articles 110. The glass articles 110 are dipped to the level of either the lip (see FIG. 1 and FIG. 2) or the rim (see FIG. 3) of the glass article 110 and may be rotated such that the level of the silicone rubber dispersion covers the entire portion of the glass article 110 below the lip or rim. Alternately, the dipping fixture may be rotated such that the glass article 110 is perpendicular to the silicone dispersion at the level of the lip or rim to fully coat the glass article 110 up to the lip or rim. In the event the bumper type configuration is to be provided by the coating itself, such as would be optional in the examples of FIGS. 2 and 3, additional thickness of the coating at this area may be obtained by successive layers of the coating be applied in this area. One of ordinary skill in the art will appreciate and understand that any desired thickness of coating may be acquired. For a uniform coating, the glass article 110 is maintained in the dispersion for a predetermined time, such as 5-10 seconds, to ensure even coating on the entire exterior surface of bottle 10, all the way to lip or rim (or other desired location). The glass articles 110 are then angled and removed from the silicone dispersion at a predetermined speed at 32 to provide an even coating over the entire outer surface of the glass articles 110. Multiple dipping cycles may be employed to gain the desired coating thickness. The movement of the glass articles 110 may be paused at the point that the glass article just exits the dispersion to allow any extra material to detach via the surface tension of the dispersion. Once removed from the dispersion, the coated glass articles 110 are flipped, such as 180 degrees, at 34. The coated glass articles 110 may also be rotated after removal from the dispersion to substantially prevent movement of the coating by forces of gravity. The coating 110 on the glass articles 110 is then dried at 36, such as by heating and/or air circulation, until solvents are evaporated and curing/polymerization of the coating is achieved. For example, an oven type arrangement may be used to facilitate curing of the silicone and evaporation of the solvent(s) therein.

The silicone dispersion in which the glass articles 110 are dipped is viscous and is circulated and filtered constantly in order to keep it from setting prematurely. As the dispersion is subjected to constant circulation and has a predetermined viscosity, uniform coating to the desired level on the bottles may be facilitated by control of the depth of the dispersion in the dip tank such as by providing a weir or dam over which the liquid dispersion flows to a re-circulation pump. Other methods of maintaining the desired depth of dispersion may be used, such as depth sensors monitoring the surface of the dispersion to obtain a precise distance from the surface of the material to a fixed predetermined point. The dipping fixture will normally have only one type of glass article 110 engaged with it at any one time, and the position of the fixture can be precisely controlled via computer control, to accurately position the glass articles 110 relative to the dispersion. As shown in FIG. 5, the dipping system 50 may include a dip tank 52 and dipping fixture 54 is shown, with the dipping fixture 54 comprised of at least one work piece holding bar 56. The holding bar 56 may include holding one or more rows of glass article 110 therewith, which each row selectively dipped into the dip tank 52, to increase throughput. The holding bar 56 may be selectively pivoted at a desired entrance/removal angle, and to flip the coated glass articles 110 after coating, by a suitable pivoting/rotating system. The vertical elevation of the holding bar 56 is controlled very accurately as it dips into the tank 52 of coating solution. The vertical elevation of the silicone dispersion is also known very accurately. As noted previously, a weir or level sensor keeps the level of the dispersion in the tank 52 constant. If desired, the tank 52 may also be supported on suitable vertical movers 58, such as motor driven screw jacks or the like, to raise or lower the tank 52. Alternately, the level of the dispersion in the tank 52 may be monitored and the amount of movement of the holding bar may be adjusted accordingly to dip the glass articles 110 to the desired depth. The proper dip level may be established by running a test dip of the glass article 110 and then examining that test piece. If the level of the dip tank needs to be adjusted the level can be accurately adjusted using the dispersion depth measurement and/or level of the dip tank 52. The level of dispersion in the tank 52 may remain constant, and once the proper level is set, the production pieces may be quickly and easily dipped into the dispersion. If discrepancies develop during a production run, the level of the dip tank 52 may be adjusted automatically or manually during the production run. The dip tank 52 may be enclosed in a hood assembly 60 to allow evacuation of any evaporated solvents, and to allow the application of a vacuum after coating for removal of any bubbles. After coating, the dipped glass articles 110 may be removed from the dip tank hood assembly and may be moved to and/or through a drying system 62, such as an oven, air circulation system or the like.

In another example, the system may allow for coating of glass articles 110 with a protective silicone rubber material by dipping the glass articles 110 into the silicone dispersion provided in a dip tank 52 or by being sprayed, via a conveyor system for moving the glass articles 110 through the coating machine (not shown). A fixture supporting a plurality of glass articles 110 in an angled position relative to the surface of the silicone dispersion in said tank so that a predetermined area of each of the glass articles 110 is dipped into the protective silicone material as they are moved through the machine.

These methods of forming the coated glass articles 110 provides a seamless sleeve on the glass articles 110, that is adhered directly to the exterior surface of the glass articles 110, with a desired thickness. An automatic control system, well known in the art, may be used to control the rate of immersion and withdrawal as well as the period of submersion. The length of time of submersion and the number of submersions determines the thickness of the coating. The coating 112 on the glass articles 110 may be air or oven dried after one or more submersions or after each submersion, assuring that the at least one solvent is evaporated. For example, drying by air drying may be for about one hour for one coat depending on thickness, with additional drying time if multiple coats are used. Using heat to facilitate drying, the coated glass articles 110 may be placed into 100 degrees F. for about 25 minutes for example, depending on thickness. The temperature in which the coated bottles may be dried may vary from about 100 to 200 degrees F. for example, depending on the coating composition, solvents and solvent handling systems for example. Higher temperatures may be possible. The time may vary based upon the thickness of the coating, temperature or other factors. Other methods of drying may be utilized. If desired, immediately upon withdrawal, after the final dispersion dip, the coated glass articles 110 may be exposed within a high vapor content chamber, such as a steam saturated atmosphere with an ambient temperature of less than 120 degrees F., for about 30 seconds or until a fine, non-coalescing layer of condensate has been deposited over the surface of the uncured glass article coating. In an example, the uncured coated glass article 110 is then allowed to dry for 15 to 30 minutes before curing at about 300 degrees F. for approximately 25 minutes in a vented oven. This may form a grippable surface on the exterior of the coating 12 to facilitate use.

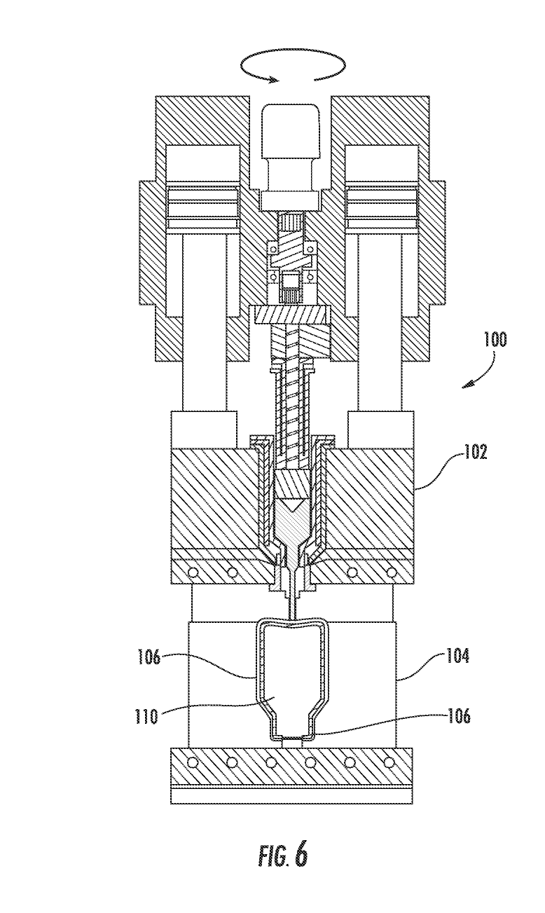

In another example, the coating 112 may be formed on the glass article 110 by an injection molding process. Referring to FIG. 6, an injection molding system 100 includes a liquid injection molding (LIM) machine 102, which for example may be a machine such as produced by Engel Austria GmbH, but other suitable machines may be used. The machine 102 is designed to handle the injection of liquid silicone, and may have a screw type or plunger type injection unit. In the example shown, a screw type injection unit is shown. The silicone may be melted for injection in the machine 102, and no solvents may be needed to form a liquid silicone for injection. A molding die 104 includes a cavity 106 having dimensions to form a desired thickness coating around the glass article 110 positioned therein, by overmolding of the silicone onto the exterior of the glass article 110. The glass article 110 is mounted via a mounting fixture 108, such as made of metal, which may be a cap-like member that the glass article 110 is screwed, or slotted into at one end of cavity 106. The mounting fixture alleviates any contact of the die with the glass article 110 upon being clamped into position for molding as shown in FIG. 6, and spaces the glass article 110 from the walls of cavity 106. In this manner, the glass article 110 is protected from breakage during the molding process. As an alternative, the glass article 110 may be filled with an incompressible liquid during the molding process to further withstand any forces acting on the glass article 110 during molding and prevent breakage. Upon actuation of the injection system of the molding machine 102, liquid silicone is forced into the space around glass article 110 to form coating 112 thereon. A vacuum may be applied and the liquid silicone may be cured in place within the mold, to remove any entrained bubbles and form a finished coated bottle product upon release from the mold.

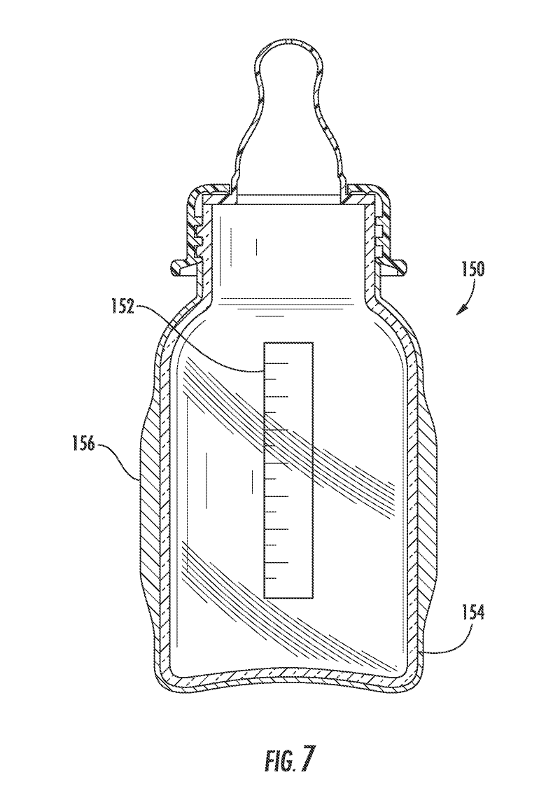

Turning to FIG. 7, a further embodiment of the invention is shown, wherein the glass article 150 is provided with a temperature sensor 152 on an exterior surface of the glass article 150 and then having a coating 154 applied per the application of a silicone coating as described with reference to prior examples. The temperature sensor 152 may be of any suitable type, and sensors such as produced by American Thermal Instruments, Inc. may be suitable for example. Alternatively, micro-dot RFID temperature sensors and liquid crystal type temperature sensors may be used. For example, micro-dot RFID temperature sensors allow the temperature to be communicated to a separate receiver, such as a countertop device, to provide an indication of temperature to the user. The sensor 152 may read the actual temperature of the liquid contents or provide an indication if the liquid contents are above (or below) a predetermined temperature, to protect from burning a baby's mouth for example. The effect of the glass thickness may be accounted for in the calibration of the temperature sensor 152. The sensor 152 may be applied to the exterior surface of the glass article 150 where thermal conductivity through the glass will allow an accurate reading of the temperature of the liquid contents, with the exterior surface then coated with a silicone layer 154 to encapsulate the temperature sensor. The coating 154 will protect the temperature sensor 152, even in the washing machine or the like. The coating 154 may also provided with a thicker portion 156 at the location where the glass article 150 is generally handled to provide additional insulation from hot liquids, substantially preventing the heat (or cold) of a liquid in the bottle from migrating to the hand of the baby or other person handling the glass article 150.

Although the invention has been shown and described in conjunction with examples thereof, the same are considered as illustrative and not restrictive, and that all changes and modifications that come within the spirit of the invention described by the following claims are within the scope thereof.

What is claimed is:

1. A coated glass baby bottle comprising,
a glass baby bottle substrate;
at least one layer of a BPA free, shatterproof silicone material having a predetermined thickness such that the coating provides shock resistance to normal dropping of the baby bottle to facilitate preventing the bottle from shattering or “exploding” if or when dropped, and total glass containment within the silicone coating if the bottle does break.

2. The coated glass baby bottle of claim 1, wherein the coating further provides thermal insulation to maintain the temperature of liquids disposed therein and keep the heat (or cold) of liquids in the bottle from migrating to the hand of the baby or other person handling the bottle.

3. The coated glass baby bottle of claim 1, wherein the coating is formed of FDA compliant silicone materials.

4. The coated glass baby bottle of claim 1, wherein the coating increasing the tensile strength in the coated article.

5. The coated glass baby bottle of claim 1, wherein the coating includes one or more colors, while allowing viewing of the contents.

6. The coated glass baby bottle of claim 1, wherein the coating is chemically stable at higher temperatures to allow the bottle to be machined washed, microwaved or boiled without degradation of the coating. or the like.

7. The coated glass baby bottle of claim 1, wherein the coating bonds to the glass substrate.

8. The coated glass baby bottle of claim 1, wherein the coating is formed so as to be substantially free of encapsulated bubbles.

9. A method of manufacture of a coated glass article comprising
providing an apparatus for coating one or more articles with a protective material by dipping the bottles into the protective material in a dip tank, including a fixture for holding at least one glass article,
formulating a silicone dispersion in the dip tank,
removing encapsulated bubbles from the dispersion,
recirculating and filtering the dispersion in the dip tank,
measuring the viscosity of the dispersion and maintaining a predetermined viscosity,
positioning at least one article on the fixture,
dipping the at least one article into the dispersion at a predetermined speed,
removing the at least one article from the dispersion at a predetermined speed,
flipping the at least one article upon removal from the dispersion and curing the coating on the at least one article.

10. A coated glass article comprising,
a glass vessel substrate;
at least one layer of BPA free, shatterproof material having a predetermined thickness such that the coating provides shock resistance to normal dropping of the coated glass vessel to facilitate preventing the coated glass vessel from shattering if or when dropped, and providing glass containment within the silicone coating if the coated glass vessel does break.

11. The coated glass vessel of claim 10, wherein the coating further provides thermal insulation to maintain the temperature of liquids disposed therein and keep the temperature of the liquids in the vessel from migrating to the hand of the person handling the vessel.

12. The coated glass vessel of claim 10, wherein the coating is formed of FDA compliant silicone materials.

13. The coated glass vessel of claim 10, wherein the coating increasing the tensile strength in the glass vessel.

14. The coated glass vessel of claim 10, wherein the coating includes one or more colors, while allowing viewing of the contents of the vessel.

15. The coated glass vessel of claim 10, wherein the coating is chemically stable at higher temperatures to allow the vessel to be machined washed, microwaved or boiled without degradation of the coating, or the like.

16. The coated glass vessel of claim 10, wherein the coating bonds to the glass substrate.

17. The coated glass vessel of claim 10, wherein the coating is formed so as to be substantially free of encapsulated bubbles.

18. The coated glass vessel of claim 10, wherein the glass vessel further comprises a protective bumper operatively connected to its bottom surface for substantially reducing the shock to the glass vessel in the event of a typical drop.
